(19) United States
(12) Patent Application Publication
(10) Pub. No.: US 2016/0058240 A1
(43) Pub. Date: Mar. 3, 2016

(54) MAKER FOR DRIP COFFEE

(71) Applicant: Sangoun NAM, Busan (KR)

(72) Inventor: Sangoun NAM, Busan (KR)

(21) Appl. No.: 14/888,056

(22) PCT Filed: Apr. 29, 2014
(86) PCT No.: PCT/KR2014/003788

§ 371 Date: Oct. 29, 2015

(30) Foreign Application Priority Data
Apr. 29, 2013 (KR) 10-2013-0047703
Nov. 13, 2013 (KR) 10-2013-0137892
Apr. 28, 2014 (KR) 10-2014-0050932

(51) Int. Cl. A47J 31/46; A47J 31/10

(52) U.S. Cl. CPC A47J 31/46; A47J 31/10

(57) ABSTRACT

Provided is a drip coffee maker comprising: a first receptacle; a second receptacle; and a third receptacle, wherein water accommodated in the second receptacle is gradually discharged through the second through hole at a predetermined flow rate per time by means of surface tension and viscosity of water. The first receptacle has a first through hole at the lower end portion thereof to discharge water downward. The second receptacle accommodates water discharged from the first through hole, is disposed at the lower side of the first receptacle and has a plurality of second through holes at the lower end portion thereof to discharge water accommodated therein onto coffee powder. The third receptacle accommodates the coffee powder and water discharged from the second through hole, is disposed at the lower side of the second receptacle and has a third through hole at the lower end portion thereof so that extracted drip coffee can be discharged downwardly.

### TECHNICAL FIELD

The present invention relates to a maker for drip coffee, and more particularly, to a maker for drip coffee for spraying water to a large area of coffee powder at a small flow rate within about 3 minutes by using surface tension and viscosity of water.

### BACKGROUND ART

Drip coffee refers to coffee that is extracted from coffee powder, obtained by finely grinding coffee beans, by pouring boiling water onto the coffee powder.

As shown in FIG. 1, the drip coffee is obtained by putting ground coffee powder C in a paper filter F, placing the paper filter F in a funnel-shaped maker D for drip coffee, and pouring water into the maker D for drip coffee by holding a kettle K by a hand as if a circle is drawn with the water in the coffee powder C from a center of the maker D for drip coffee so that an amount of the poured water is adjusted.

Particularly, in the case of drip coffee, if a small amount of water is primarily poured onto the coffee powder C in advance, a coffee ingredient present in a cell wall of the coffee powder C is soaked in advance. Then, if a great amount of water is secondarily poured on the coffee powder C, as carbon dioxide which is present in a cell of the coffee powder C expands, a strong coffee component is extracted, and thus, extracted coffee is dripped into and fills a coffee receptacle B.

As such, if the maker D for drip coffee in a related art is used, since a taste of extracted drip coffee varies depending on an amount of water poured onto the coffee powder C and a speed and time for which water is poured, a taste and aroma vary depending on mastery of a person who pours water into the maker D for drip coffee. Accordingly, since general people other than baristas who received regular training and have a long experience may not appropriately and uniformly supply water into the maker D for drip coffee, it may be difficult for them to make good taste coffee.

### DETAILED DESCRIPTION OF THE INVENTION

### Technical Problem

The present invention is to solve a problem such that it is difficult for a non-expert to make good taste coffee. The present invention provides a maker for drip coffee having an improved structure in which water is gradually sprayed on a large area of coffee powder at a small flow rate within 3 minutes by using surface tension and viscosity of water.

### Technical Solution

According to an exemplary embodiment of the present invention, there is provided a maker for drip coffee configured to make drip coffee by pouring water to coffee powder obtained by finely grinding coffee beans, the maker for drip coffee including: a first receptacle configured to accommodate water and comprise a first through hole at a lower part of the first receptacle so as to discharge water downwards; a second receptacle configured to accommodate the water discharged from the first through hole, be disposed below the first receptacle, and comprise a plurality of second through holes at a lower part of the second receptacle, so as to discharge water accommodated in the second receptacle onto the coffee powder; a third receptacle configured to accommodate the coffee powder and water discharged from the plurality of second through holes, be disposed below the second receptacle, and comprise a third through hole at a lower part of the third receptacle, so as to discharge extracted drip coffee downwards, wherein the water accommodated in the second receptacle is gradually discharged through the plurality of second through holes at a predetermined flow rate according to surface tension and viscosity of water.

The first receptacle may have a shape of an inverted funnel-type cone or an inverted funnel-type truncated cone whose inner diameter is reduced toward a lower part of the first receptacle with a predetermined inclination angle, wherein the first through hole is disposed at a center axis of the cone or the truncated cone.

The first receptacle may have a size such that the first receptacle accommodates 160 to 500 mL of water, and the second receptacle may have a size such that the second receptacle accommodates 20 to 60 mL of water.

The inclination angle of the first receptacle may be 60 to 70 degrees.

In the second receptacle, the plurality of through holes may not be present on a virtual vertical line extending vertically in a downward direction from the first through hole.

In the second receptacle, the plurality of second through holes may be disposed on a plurality of concentric circles having a center at a center axis of the inverted cone or inverted truncated cone.

The maker for drip coffee may further include an insulation unit for keeping warm at least one selected from the group consisting of the first receptacle and the second receptacle.

At least one selected from the group consisting of the first receptacle and the second receptacle may include a transparent or semi-transparent synthetic resin material.

A length of the plurality of second through holes may be 1 to 2 mm.

A lower part of the second receptacle may lower part of the second receptacle may be connected to a plurality of branch pipes having a predetermined length and a predetermined inner diameter, the plurality of second through holes may be formed at ends of the plurality of branch pipes.

The plurality of branch pipes may extend horizontally and radially from the center axis of the second receptacle, and be disposed circumferentially from the center axis of the second receptacle.

The maker for drip coffee may further include a cleaning hole formed at ends of the plurality of branch pipes, and a cover configured to detachably close the cleaning hole.

The maker for drip coffee may further include guide members that are pipe-type members disposed to surround peripheries of the second through holes, and protrude from the plurality of second through holes in a predetermined length.

The second receptacle may have a dual receptacle structure in which an inner space is separated by a space separation unit so that time for which water accommodated in the second receptacle is discharged through the plurality of second through holes is increased.

The space separation unit may include a vertical barrier which is a pipe-type member which extends in a predetermined length and whose both ends are open and is disposed inside the second receptacle in a longitudinal direction, and whose lower part is disposed to surround one or more of the plurality of second through holes in a watertight manner so as to separate an inner space of the second receptacle into a center part and an outer part.

The space separation unit may include a horizontal barrier which is a member disposed in a horizontal direction so as to divide an inner space of the second receptacle into an upper part and a lower part, and includes a fourth through hole formed to discharge water accommodated in the upper part of the inner space into the lower part of the inner space.

The third receptacle may include a side surface part that has a shape of a circular pipe and is disposed below the second receptacle, and a bottom part that has a shape of a circular strip and is formed to close an edge of the lower part of the side surface part in a predetermined width, and the third through hole may be formed by an inner circumferential surface of the bottom part.

### Advantageous Effects of the Invention

The present invention provides a first receptacle configured to accommodate water and include a first through hole at a lower part of the first receptacle so as to discharge water downwards, and a second receptacle configured to accommodate water discharged from the first through hole, be disposed below the first receptacle, and include a plurality of second through holes at a lower part of the second receptacle, so as to discharge water accommodated therein to the coffee powder, wherein a diameter of the first receptacle is 1.4 to 1.9 mm, a diameter of the plurality of second through holes is 0.4 to 0.9 mm, and the water accommodated in the second receptacle is gradually discharged through the plurality of through holes according to surface tension and viscosity of water at a predetermined flow rate. Thus, water may be gradually sprayed onto a large area of the coffee powder at a flow rate having a small value within 3 minutes, due to surface tension and viscosity caused by a buffering function performed by the second receptacle and a minute diameter of the plurality of second through holes.

### DESCRIPTION OF THE DRAWINGS

FIG. 1 is a diagram for explaining a method of extracting drip coffee from coffee powder by using a maker for drip coffee in a related art

FIG. 2 is a perspective view of a maker for drip coffee according to an exemplary embodiment;

FIG. 3 is a cross-sectional view of the maker for drip coffee taken along line I-I shown in FIG. 2;

FIG. 4 is a cross-sectional view of the maker for drip coffee taken along line II-II shown in FIG. 3;

FIG. 5 is a cross-sectional view of the maker for drip coffee taken along line III-III shown in FIG. 3;

FIG. 6 is a cross-sectional view of the maker for drip coffee taken along line IV-IV shown in FIG. 3;

FIG. 7 is a diagram for explaining a state of use of the maker for drip coffee shown in FIG. 3;

FIG. 8 is a graph showing a flow rate of water discharged from a first receptacle included in the maker for drip coffee shown in FIG. 3;

FIG. 9 is a graph showing a flow rate of water discharged from a second receptacle included in the maker for drip coffee shown in FIG. 3;

FIG. 10 is a partially magnified cross-sectional view of the first receptacle and the second receptacle included in the maker for drip coffee shown in FIG. 3;

FIG. 11 is a diagram showing a second receptacle included in a maker for drip coffee according to another exemplary embodiment;

FIG. 12 is a bottom view of the second receptacle shown in FIG. 11;

FIG. 13 is a diagram illustrating a maker for drip coffee in which the second receptacle, shown in FIG. 11, is mounted;

FIG. 14 is a diagram showing a second receptacle included in a maker for drip coffee according to another exemplary embodiment; and

FIG. 15 is a diagram showing a second receptacle included in a maker for drip coffee according to another exemplary embodiment.

### BEST MODE

Hereinafter, exemplary embodiments of the present invention will be described more fully with reference to the accompanying drawings, in which exemplary embodiments are shown.

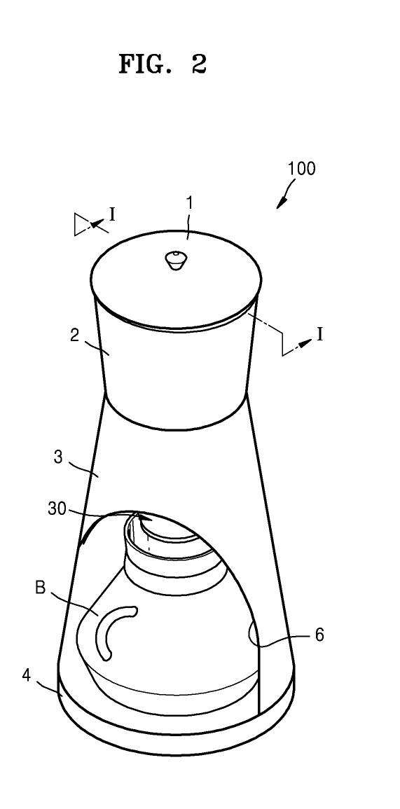

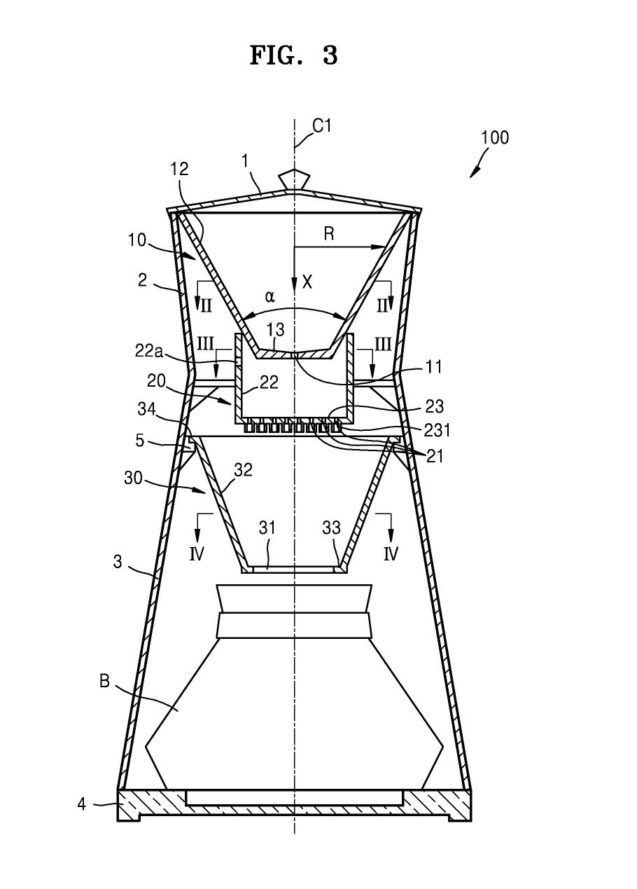

FIG. 2 is a perspective view of a maker 100 for drip coffee according to an exemplary embodiment. FIG. 3 is a cross-sectional view of the maker 100 for drip coffee taken along line I-I shown in FIG. 2.

Referring to FIGS. 2 and 3, according to an exemplary embodiment, the maker 100 for drip coffee is a maker for drip coffee for extracting drip coffee from coffee powder C, obtained by finely grinding coffee beans, by pouring water onto the coffee powder C. The maker 100 for drip coffee includes an outer casing, a first receptacle 10, a second receptacle 20, a third receptacle 30, and an insulation unit.

The outer casing is formed of a transparent synthetic resin material, and includes an upper case 2 and a lower case 3.

The upper case 2 is a circular pipe-type case extending in a vertical direction in a predetermined length, and has a vertical line C1, formed in a longitudinal direction, as a center axis C1.

A round cover 1 which may detachably close an upper part of the upper case 2, is mounted in the upper part of the upper case 2.

The lower case 3 is a circular pipe-type case extending in a vertical direction in a predetermined length. The lower case 3 is disposed below the upper case 2, and has the vertical line C1 as the center axis C1.

An upper part of the lower case 3 connects to a lower part of the upper case 2, and a receptacle storage hole 6 through which the third receptacle 30 may enter or exit is formed on a side surface of the lower part of the lower case.

A base 4 is attached to a lower part of the lower case 3 and formed to close the lower part of the lower case 3.

A stopping step 5 is formed on a part of an inner circumferential surface of the upper part of the lower case 3 circumferentially with respect to the center axis C1. The stopping step 5 has a shape protruding toward the center axis C1.

The first receptacle 10 is formed of a transparent synthetic resin material and disposed inside the upper case 2. The first receptacle 10 may accommodate water poured from above through an opening at an upper part the first receptacle 10. The first receptacle 10 includes a first through hole 11, an inclined part 12, and a bottom part 13.

As shown in FIG. 3, the inclined part 12 is a funnel-shaped circular pipe-type part whose inner diameter R is reduced toward a lower part of the inclined part 12 in a downward direction X with a predetermined inclination angle α. The inclined part 12 has the vertical line C1, formed to extend in a longitudinal direction, as the center axis C1.

The inclined part 12 is accommodated inside the upper case 2 so that an upper part of the inclined part 12 is connected to the upper part of the upper case 2.

The bottom part 13 is a circular plate formed to close a lower part of the inclined part 12, and has the vertical line C1 as a center of a circle.

In the current embodiment, the first receptacle 10 has a shape of an inverted truncated cone having a predetermined inclination angle α.

The first through hole 11 is a round hole formed at the center C1 of the bottom part 13, and is a path via which water, accommodated in the first receptacle 10, freely falls downwards and is discharged.

The inclination angle α may be selected from values ranging from 60 to 70 degrees. Assuming that the first receptacle 10 accommodates a constant amount of water and includes the bottom part 13 having a constant diameter and the through hole 11 having a constant diameter, if the inclination angle α is decreased, a flow rate of water discharged via the first through hole 11 is reduced. In the current embodiment, the inclination angle α is 63 degrees.

Here, a flow rate q1 of water discharged via the first through hole 11 is proportional to a diameter of the first through hole 11 and a level of water accommodated in the first receptacle 10.

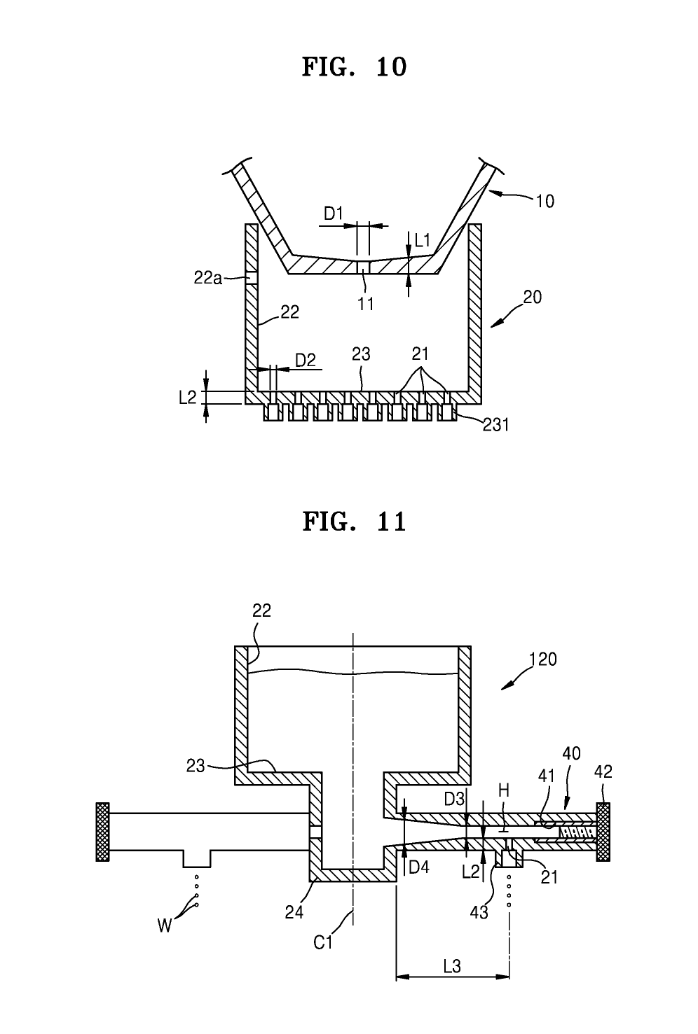

As shown in FIG. 10, in the first receptacle 10, a diameter D1 of the first through hole 11 1.4 to 1.9 mm, and a length L1 of the first through hole 11 is 1.0 to 2.0 mm.

In the current embodiment, the first receptacle 10 has a size such that the first through hole 11 has the diameter D1 of 1.6 mm, and may accommodate 160 to 500 ml of water.

Like the first receptacle 10, the second receptacle 20 is formed of a transparent synthetic material. The second receptacle 20 is disposed in the external cases 2 and 3 and below the first receptacle 10 to temporarily accommodate water discharged from the first through hole 11. The second receptacle 20 includes second through holes 21, a side surface part 22, and a bottom part 23.

The side surface part 22 is a circular pipe-type part extending in a longitudinal direction in a predetermined length, and has the vertical line C1 as the center axis C1.

An upper part of the side surface part 22 is connected to an outer circumferential surface of the inclined part 12 of the first receptacle 10.

A vent 22a into which external air flows is formed at a side surface of the upper part of the side surface part 22 so that water accommodated in the second receptacle 20 is smoothly discharged through the second through holes 21.

A bottom part 23 is a circular plate formed to close a lower part of the inclined part 12, and has the vertical line C1 as a center of a circle.

The second through holes 21 are a plurality of round holes formed at the bottom part 23, and paths via which water, accommodated in the second receptacle 20, freely falls downwards and is discharged. In the current embodiment, 14 second through holes 21 are formed.

A plurality of guide members 231 that are circular pipe members are provided and connected to a bottom surface of the bottom part 23 in a watertight manner.

The guide members 231 are disposed so that one end of the guide members 231 surround peripheries of the through holes 21.

Other ends of the guide members 231 protrude from a bottom surface of the bottom part 23 in a predetermined length.

The guide members 231 may prevent water, discharged from the second through holes 21, from flowing and moving along a surface of the bottom part 23 in a horizontal direction, and guide the water to fall downward to a correct position.

A flow rate q2 of water discharged via the second through holes 21 is proportional to a diameter of the second through holes 21 and a level of water accommodated in the second receptacle 20.

As shown in FIG. 10, a diameter D2 of the second through holes 21 is 0.4 to 0.9 mm, and a length L2 of the second through holes 21 is 1.0 to 2.0 mm, so that the water accommodated in the second receptacle 20 is gradually discharged via the second through holes 21 at a predetermined flow rate q2 according to surface tension and viscosity.

In the current embodiment, the second receptacle 20 has a size such that the second through holes 21 has the diameter D2 of 0.5 mm and the length L2 of 1.4 mm, and may accommodate 20 to 60 ml of water.

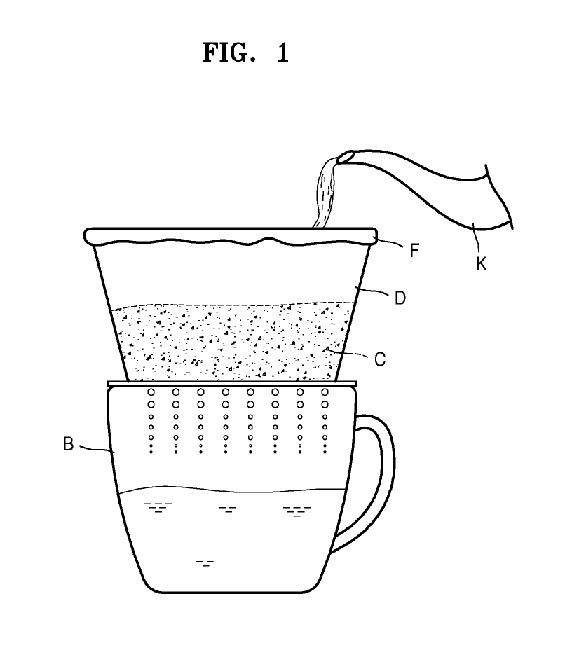

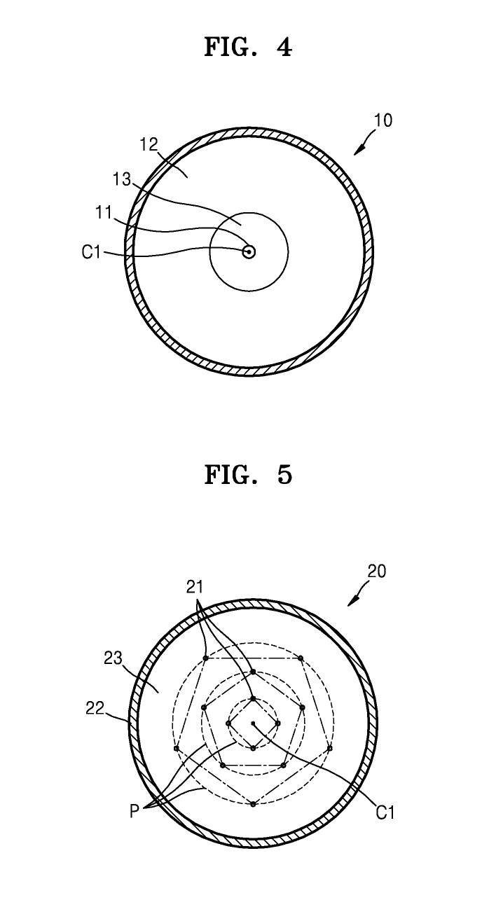

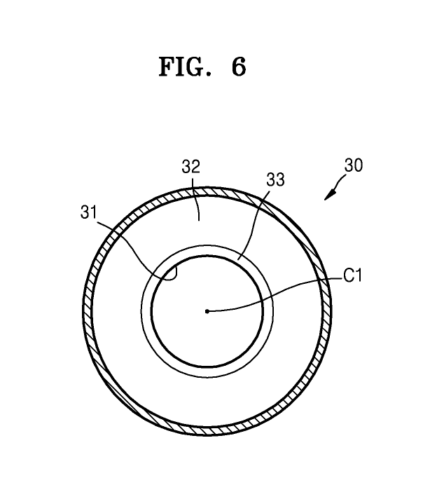

Diameters and lengths of the first through hole 11 and the second through holes 21 are determined based on experimental data shown in FIGS. 1 through 4. Here, it is assumed that 250 mL of water W is poured into the first receptacle 10.

TABLE 1
A case when the diameter D2 of the second through holes 21 equals to 0.4 mm is shown.

| Receptacle | First | Second | Third | First | Second | Third | First | Second | Third | First | Second | Third |
|---|---|---|---|---|---|---|---|---|---|---|---|---|
| Dimension | 1.4 | 0.4 | — | 1.6 | 0.4 | — | 1.8 | 0.4 | — | 2.0 | 0.4 | — |
| (mm) | | | | | | | | | | | | |
| Time (sec) | | | | | | | | | | | | |
| 10″ | 14 | 12 | 2 | 20 | 17 | 3 | 24 | 20 | 4 | 31 | 26 | 5 |
| 20″ | 30 | 22 | 8 | 42 | 30 | 12 | 49 | 35 | 14 | 61 | 45 | 16 |
| 30″ | 44 | 28 | 16 | 63 | 40 | 23 | 73 | 48 | 25 | 88 | 58 | 30 |
| 40″ | 59 | 34 | 25 | 83 | 47 | 36 | 94 | 56 | 38 | 116 | 71 | 45 |
| 50″ | 72 | 37 | 35 | 103 | 53 | 50 | 120 | 66 | 54 | 142 | 80 | 62 |
| 60″ | 86 | 41 | 45 | 122 | 59 | 63 | 142 | 70 | 72 | 167 | 86 | 81 |
| 70″ | 100 | 44 | 56 | 141 | 62 | 79 | 163 | 75 | 88 | 191 | 90 | 101 |
| 80″ | 113 | 46 | 67 | 159 | 65 | 94 | 183 | 78 | 105 | 212 | 92 | 120 |
| 90″ | 126 | 47 | 79 | 176 | 66 | 110 | 202 | 79 | 123 | 232 | 93 | 139 |
| 100″ | 139 | 49 | 90 | 192 | 66 | 126 | 218 | 77 | 141 | 247 | 87 | 160 |
| 110″ | 151 | 50 | 101 | 208 | 66 | 142 | 235 | 77 | 158 | | 70 | 177 |
| 120″ | 163 | 50 | 113 | 222 | 63 | 159 | 248 | 72 | 176 | | 54 | 193 |
| 130″ | 174 | 50 | 124 | 236 | 62 | 174 | | 57 | 204 | | 41 | 206 |
| 140″ | 186 | 50 | 136 | 247 | 57 | 190 | | 44 | 215 | | 28 | 219 |
| 150″ | 196 | 48 | 148 | | 44 | 203 | | 33 | 224 | | 19 | 228 |
| 160″ | 207 | 48 | 159 | | 32 | 215 | | 24 | 231 | | 11 | 236 |
| 170″ | 217 | 47 | 170 | | 22 | 225 | | 17 | 236 | | 5 | 242 |
| 180″ | 227 | 46 | 181 | | 14 | 233 | | 12 | 240 | | | |
| 190″ | 236 | 45 | 191 | | 8 | 239 | | 8 | | | | |
| 200″ | 244 | 42 | 202 | | 4 | 243 | | | | | | |
| 210″ | 249 | 38 | 211 | | | | | | | | | |
| 220″ | | 29 | 220 | | | | | | | | | |
| 230″ | | 22 | 227 | | | | | | | | | |

As shown in Table 1, in a case when it takes 150 to 180 seconds to discharge whole water accommodated in the second receptacle 20, the diameter D1 of the first receptacle 10 is 1.0 or 2.0 mm, but levels of water in the second receptacle 20 are respectively 79 mm and 93 mm at a time point of 90 seconds. Since the levels of the water are too high, this case is not appropriate. Accordingly, the diameter D2 of the second through holes 21 is required to be greater than 0.4 mm. Here, a level of the water in the second receptacle 20 is proportional to a pressure of water passing through the second through holes 21.

TABLE 2
A case when the diameter D2 of the second through holes 21 equals to 0.5 mm is shown.

| Receptacle | First | Second | Third | First | Second | Third | First | Second | Third | First | Second | Third |
|---|---|---|---|---|---|---|---|---|---|---|---|---|
| Dimension | 1.4 | 0.6 | — | 1.6 | 0.6 | — | 1.8 | 0.6 | — | 2.0 | 0.6 | — |
| (mm) | | | | | | | | | | | | |
| Time | | | | | | | | | | | | |
| (seconds) | | | | | | | | | | | | |
| 10″ | 14 | 9 | 5 | 20 | 14 | 6 | 24 | 16 | 8 | 31 | 22 | 9 |
| 20″ | 30 | 14 | 16 | 42 | 24 | 18 | 49 | 25 | 24 | 61 | 35 | 26 |
| 30″ | 44 | 18 | 26 | 63 | 31 | 32 | 73 | 32 | 41 | 88 | 45 | 43 |
| 40″ | 59 | 20 | 39 | 83 | 34 | 49 | 94 | 34 | 60 | 116 | 54 | 62 |
| 50″ | 72 | 21 | 51 | 103 | 41 | 62 | 120 | 39 | 81 | 142 | 59 | 83 |
| 60″ | 86 | 21 | 65 | 122 | 42 | 80 | 142 | 41 | 101 | 167 | 64 | 103 |
| 70″ | 100 | 22 | 78 | 141 | 43 | 98 | 163 | 42 | 121 | 191 | 67 | 124 |
| 80″ | 113 | 22 | 91 | 159 | 42 | 117 | 183 | 42 | 141 | 213 | 67 | 146 |
| 90″ | 126 | 22 | 104 | 176 | 40 | 136 | 202 | 41 | 161 | 232 | 67 | 165 |
| 100″ | 139 | 22 | 117 | 192 | 39 | 153 | 218 | 36 | 182 | 247 | 62 | 185 |
| 110″ | 151 | 21 | 130 | 208 | 39 | 169 | 235 | 34 | 201 | | 43 | 204 |
| 120″ | 163 | 20 | 143 | 222 | 36 | 186 | 248 | 30 | 218 | | 26 | 221 |
| 130″ | 174 | 18 | 156 | 236 | 33 | 203 | | 14 | 234 | | 11 | 236 |
| 140″ | 186 | 18 | 168 | 247 | 30 | 217 | | 5 | 243 | | 0 | 247 |
| 150″ | 196 | 16 | 180 | | 16 | 231 | | 0 | 248 | | | |
| 160″ | 207 | 15 | 192 | | 5 | 242 | | | | | | |
| 170″ | 217 | 13 | 204 | | 0 | 247 | | | | | | |
| 180″ | 227 | 12 | 215 | | | | | | | | | |
| 190″ | 236 | 11 | 225 | | | | | | | | | |
| 200″ | 244 | 8 | 236 | | | | | | | | | |
| 210″ | 249 | 4 | 245 | | | | | | | | | |
| 220″ | | | | | | | | | | | | |
| 230″ | | | | | | | | | | | | |

As shown in Table 2, in a case when it takes 150 to 180 seconds to discharge whole water accommodated in the second receptacle 20, the diameter D1 of the first receptacle 10 is 1.6 or 1.8 mm. In this case, levels of water in the second receptacle 20 are respectively 43 mm and 42 mm at a time point of 70 seconds, and thus, the levels of the water are appropriate.

TABLE 3
A case when the diameter D2 of the second through holes 21 equals to 0.6 mm is shown.

| Receptacle | First | Second | Third | First | Second | Third | First | Second | Third | First | Second | Third |
|---|---|---|---|---|---|---|---|---|---|---|---|---|
| Dimension | 1.4 | 0.5 | — | 1.6 | 0.5 | — | 1.8 | 0.5 | — | 2.0 | 0.5 | — |
| (mm) | | | | | | | | | | | | |
| Time | | | | | | | | | | | | |
| (seconds) | | | | | | | | | | | | |
| 10″ | 14 | 9 | 5 | 20 | 13 | 7 | 24 | 16 | 8 | 31 | 22 | 9 |
| 20″ | 30 | 15 | 15 | 42 | 21 | 21 | 49 | 27 | 22 | 61 | 37 | 24 |
| 30″ | 44 | 17 | 27 | 63 | 26 | 37 | 73 | 35 | 38 | 88 | 46 | 42 |
| 40″ | 59 | 20 | 39 | 83 | 29 | 54 | 94 | 38 | 56 | 116 | 50 | 66 |
| 50″ | 72 | 20 | 54 | 103 | 31 | 72 | 120 | 44 | 76 | 142 | 57 | 85 |
| 60″ | 86 | 20 | 66 | 122 | 32 | 90 | 142 | 45 | 97 | 167 | 59 | 108 |
| 70″ | 100 | 20 | 80 | 141 | 33 | 108 | 163 | 45 | 118 | 191 | 59 | 132 |
| 80″ | 113 | 19 | 94 | 159 | 33 | 126 | 183 | 43 | 140 | 212 | 56 | 156 |
| 90″ | 126 | 19 | 107 | 176 | 33 | 143 | 202 | 42 | 160 | 232 | 55 | 177 |
| 100″ | 139 | 19 | 120 | 192 | 31 | 161 | 218 | 39 | 179 | 247 | 46 | 201 |
| 110″ | 151 | 17 | 134 | 208 | 29 | 179 | 235 | 36 | 199 | | 28 | 219 |
| 120″ | 163 | 17 | 146 | 222 | 27 | 195 | 248 | 31 | 217 | | 12 | 235 |
| 130″ | 174 | 15 | 159 | 236 | 25 | 211 | | 16 | 232 | | 0 | 247 |
| 140″ | 186 | 15 | 171 | 247 | 22 | 225 | | 7 | 241 | | | |
| 150″ | 196 | 12 | 184 | | 9 | 238 | | 0 | 247 | | | |
| 160″ | 207 | 12 | 195 | | 0 | 247 | | | | | | |
| 170″ | 217 | 11 | 206 | | | | | | | | | |
| 180″ | 227 | 10 | 217 | | | | | | | | | |
| 190″ | 236 | 9 | 227 | | | | | | | | | |
| 200″ | 244 | 8 | 236 | | | | | | | | | |
| 210″ | 249 | 5 | 244 | | | | | | | | | |
| 220″ | | 0 | 249 | | | | | | | | | |
| 230″ | | | | | | | | | | | | |

As shown in Table 3, in a case when it takes 150 to 180 seconds to discharge whole water accommodated in the second receptacle 20, the diameter D1 of the first receptacle 10 is 1.6 or 1.8 mm. In this case, levels of water in the second receptacle 20 are respectively 33 mm and 45 mm at a time point of 70 seconds, and thus, the levels of the water are appropriate.

TABLE 4
A case when the diameter D2 of the second through holes 21 equals to 0.7 mm is shown.

| Receptacle | First | Second | Third | First | Second | Third | First | Second | Third | First | Second | Third |
|---|---|---|---|---|---|---|---|---|---|---|---|---|
| Dimension | 1.4 | 0.7 | — | 1.6 | 0.7 | — | 1.8 | 0.7 | — | 2.0 | 0.7 | — |
| (mm) | | | | | | | | | | | | |
| Time | | | | | | | | | | | | |
| (seconds) | | | | | | | | | | | | |
| 10″ | 14 | 8 | 6 | 20 | 13 | 7 | 24 | 14 | 10 | 31 | 20 | 11 |
| 20″ | 30 | 14 | 16 | 42 | 22 | 20 | 49 | 23 | 26 | 61 | 33 | 28 |
| 30″ | 44 | 16 | 28 | 63 | 25 | 38 | 73 | 26 | 47 | 88 | 38 | 50 |
| 40″ | 59 | 18 | 41 | 83 | 26 | 57 | 94 | 26 | 68 | 116 | 41 | 75 |
| 50″ | 72 | 18 | 54 | 103 | 26 | 77 | 120 | 32 | 88 | 142 | 41 | 101 |
| 60″ | 86 | 18 | 68 | 122 | 26 | 96 | 142 | 32 | 110 | 167 | 39 | 128 |
| 70″ | 100 | 18 | 82 | 141 | 26 | 115 | 163 | 31 | 132 | 181 | 37 | 154 |
| 80″ | 113 | 18 | 95 | 159 | 25 | 134 | 183 | 30 | 153 | 212 | 33 | 179 |
| 90″ | 126 | 18 | 108 | 176 | 24 | 152 | 202 | 28 | 174 | 232 | 30 | 202 |
| 100″ | 139 | 18 | 121 | 192 | 22 | 170 | 218 | 25 | 193 | 247 | 23 | 224 |
| 110″ | 151 | 16 | 135 | 208 | 20 | 188 | 235 | 23 | 212 | | 7 | 240 |
| 120″ | 163 | 14 | 149 | 222 | 17 | 205 | 248 | 19 | 229 | | 0 | 247 |
| 130″ | 174 | 12 | 162 | 236 | 15 | 221 | | 4 | 244 | | | |
| 140″ | 186 | 11 | 175 | 247 | 12 | 235 | | | | | | |
| 150″ | 196 | 9 | 187 | | 0 | 347 | | | | | | |
| 160″ | 207 | 7 | 200 | | | | | | | | | |
| 170″ | 217 | 6 | 211 | | | | | | | | | |
| 180″ | 227 | 5 | 222 | | | | | | | | | |
| 190″ | 236 | 4 | 232 | | | | | | | | | |
| 200″ | 244 | 2 | 242 | | | | | | | | | |
| 210″ | 249 | 0 | 249 | | | | | | | | | |
| 220″ | | | | | | | | | | | | |
| 230″ | | | | | | | | | | | | |

As shown in Table 4, in a case when it takes 150 to 180 seconds to discharge whole water accommodated in the second receptacle 20, the diameter D1 of the first receptacle 10 is 1.6 mm. In this case, levels of water in the second receptacle 20 are respectively 26 mm at a time point of 70 seconds, and thus, the levels of the water are too great or small.

TABLE 5
A case when the diameter D2 of the second through holes 21 equals to 0.8 mm is shown.

| Receptacle | First | Second | Third | First | Second | Third | First | Second | Third | First | Second | Third |
|---|---|---|---|---|---|---|---|---|---|---|---|---|
| Dimension | 1.4 | | | 1.6 | | | 1.8 | | | 2.0 | | |
| (mm) | | | | | | | | | | | | |
| Time | | | | | | | | | | | | |
| (seconds) | | | | | | | | | | | | |
| 10″ | 14 | 7 | 7 | 20 | 11 | 9 | 24 | 13 | 11 | 31 | 18 | 13 |
| 20″ | 30 | 11 | 19 | 42 | 20 | 22 | 49 | 22 | 27 | 61 | 28 | 33 |
| 30″ | 44 | 12 | 32 | 63 | 24 | 39 | 73 | 28 | 45 | 88 | 34 | 54 |
| 40″ | 59 | 12 | 47 | 83 | 24 | 59 | 94 | 30 | 64 | 116 | 37 | 79 |
| 50″ | 72 | 12 | 60 | 103 | 24 | 79 | 120 | 31 | 91 | 142 | 37 | 105 |
| 60″ | 86 | 12 | 74 | 122 | 24 | 98 | 142 | 31 | 111 | 167 | 37 | 131 |
| 70″ | 100 | 12 | 88 | 141 | 23 | 118 | 163 | 29 | 134 | 181 | 33 | 148 |
| 80″ | 113 | 10 | 103 | 159 | 22 | 137 | 183 | 27 | 156 | 212 | 32 | 183 |
| 90″ | 126 | 10 | 116 | 176 | 20 | 156 | 202 | 26 | 176 | 232 | 21 | 211 |
| 100″ | 139 | 9 | 130 | 192 | 18 | 174 | 218 | 24 | 198 | 247 | 13 | 234 |
| 110″ | 151 | 7 | 144 | 208 | 15 | 193 | 235 | 20 | 217 | | 0 | 247 |
| 120″ | 163 | 6 | 157 | 222 | 12 | 210 | 248 | 15 | 233 | | | |
| 130″ | 174 | 6 | 170 | 236 | 10 | 226 | | 0 | 248 | | | |
| 140″ | 186 | 4 | 182 | 247 | 6 | 241 | | | | | | |
| 150″ | 196 | 2 | 194 | | 0 | 247 | | | | | | |
| 160″ | 207 | 1 | 206 | | | | | | | | | |
| 170″ | 217 | | 217 | | | | | | | | | |
| 180″ | 227 | | 227 | | | | | | | | | |
| 190″ | 236 | | 236 | | | | | | | | | |
| 200″ | 244 | | 244 | | | | | | | | | |
| 210″ | 249 | | 249 | | | | | | | | | |
| 220″ | | | | | | | | | | | | |
| 230″ | | | | | | | | | | | | |

As shown in Table 5, in a case when it takes 150 to 180 seconds to discharge whole water accommodated in the second receptacle 20, the diameter D1 of the first receptacle 10 is 1.4 mm or 1.6 mm. In this case, levels of water in the second receptacle 20 are respectively 12 mm and 23 mm at a time point of 70 seconds. In a case when the diameter D1 of the first receptacle 10 has a value different from 1.4 mm or 1.6 mm, the levels of the water are too high.

TABLE 6
A case when the diameter D2 of the second through holes 21 equals to 0.9 mm is shown.

| Receptacle | First | Second | Third | First | Second | Third | First | Second | Third | First | Second | Third |
|---|---|---|---|---|---|---|---|---|---|---|---|---|
| Dimension | 1.4 | | | 1.6 | | | 1.8 | | | 2.0 | | |
| (mm) | | | | | | | | | | | | |
| Time | | | | | | | | | | | | |
| (seconds) | | | | | | | | | | | | |
| 10″ | 14 | 4 | 10 | 20 | 6 | 14 | 24 | 8 | 16 | 31 | 13 | 18 |
| 20″ | 30 | 4 | 26 | 42 | 9 | 33 | 49 | 12 | 37 | 61 | 20 | 41 |
| 30″ | 44 | 4 | 40 | 63 | 10 | 53 | 73 | 14 | 59 | 88 | 21 | 67 |
| 40″ | 59 | 4 | 55 | 83 | 10 | 73 | 94 | 14 | 80 | 116 | 24 | 92 |
| 50″ | 72 | 4 | 68 | 103 | 10 | 93 | 120 | 14 | 106 | 142 | 21 | 121 |
| 60″ | 86 | 2 | 84 | 122 | 9 | 113 | 142 | 14 | 128 | 167 | 19 | 148 |
| 70″ | 100 | 1 | 99 | 141 | 8 | 133 | 163 | 13 | 150 | 181 | 17 | 174 |
| 80″ | 113 | | 112 | 159 | 7 | 151 | 183 | 12 | 171 | 212 | 14 | 198 |
| 90″ | 126 | | 125 | 176 | 6 | 169 | 202 | 8 | 194 | 232 | 11 | 221 |
| 100″ | 139 | | 138 | 192 | 6 | 186 | 218 | 6 | 212 | 247 | 6 | 241 |
| 110″ | 151 | | 151 | 208 | 6 | 202 | 235 | 3 | 232 | | | 249 |
| 120″ | 163 | | 163 | 222 | 3 | 219 | 248 | 0 | 248 | | | |
| 130″ | 174 | | 174 | 236 | 2 | 234 | | | | | | |
| 140″ | 186 | | 186 | 247 | | 246 | | | | | | |
| 150″ | 196 | | 196 | | | | | | | | | |
| 160″ | 207 | | 207 | | | | | | | | | |
| 170″ | 217 | | 217 | | | | | | | | | |
| 180″ | 227 | | 227 | | | | | | | | | |
| 190″ | 236 | | 236 | | | | | | | | | |
| 200″ | 244 | | 244 | | | | | | | | | |
| 210″ | 249 | | 249 | | | | | | | | | |
| 220″ | | | | | | | | | | | | |
| 230″ | | | | | | | | | | | | |

As shown in Table 6, there are no cases when it takes 150 to 180 seconds to discharge whole water accommodated in the second receptacle 20. If the diameter D1 of the first receptacle 10 is 1.6 mm, levels of water in the second receptacle 20 are respectively 8 mm at a time point of 70 seconds, and it takes 130 seconds to discharge the whole water accommodated in the second receptacle 20, and 130 seconds is a maximum value. In a case when the diameter D1 of the first receptacle 10 has a value from 1.6 mm, time for which the water accommodated in the second receptacle 20 is discharged is too short.

As shown in FIG. 5, the second through holes 21 are not present on the virtual vertical line C extending vertically and downward from the first through hole 11, but disposed on a plurality of concentric circles P having a center at the vertical line C1 with respect to the first receptacle 10.

In the current embodiment, one or more second through holes 21 are respectively located at vertices of a virtual lozenge in a concentric circle located in an innermost area, other second through holes 21 are located at vertices of a virtual pentagon in a concentric circle P located between two concentric circles P respectively located in the innermost area and an outermost area, and remaining second through holes 21 are located at vertices of a virtual inverted pentagon in a concentric circle P located in the outermost area.

Accordingly, the maker for drip coffee has a structure such that water freely falling downward via the first through hole 11 in the first receptacle 10 does not directly pass through the second through holes 21 but stays a while in the second receptacle 20.

The third receptacle 30 is a receptacle for accommodating the coffee powder C and water discharged from the second through holes 21. The third receptacle 30 is disposed in the lower case 3 and, like the first receptacle 10, formed of a transparent synthetic resin material to have an opening at an upper part of the third receptacle 30. The third receptacle 30 includes a third through hole 31, a side surface part 32, a bottom part 33, and a locking part 34.

The side surface unit 32 is a funnel-shaped circular pipe-type part whose inner diameter is reduced toward a lower part of the side surface unit 32 in the downward direction X. The side surface part 32 has the vertical line C1 as the center axis C1, and is disposed below the second receptacle 20.

The bottom part 33 is a circular plate formed to close a lower part of the side surface part 32, and has the vertical line C1 as a center C1 of a circle.

The second through holes 31 are a plurality of round holes formed at the center C1 of the bottom part 33, and are paths via which drip coffee, extracted in the third receptacle 30, freely falls downwards and is discharged.

The locking part 34 is a protruding part formed on an outer circumferential surface of an upper part of the side surface part 32. The locking part 34 is formed on a part of a circumference of the side surface part 32 circumferentially with respect to the center axis C1. As shown in FIG. 3, the locking part 34 is supported by the stopping step 5 formed on the lower case 3.

The locking part 34 protrudes radially from the center axis C1 and may be detachably connected to the stopping step 5 formed on the lower case 3.

A structure in which the locking part 34 and the stopping step 5 are connected to each other is well-known to one of ordinary skill in the art, and thus, a detailed description thereof is not provided here. For example, a structure such that the locking part 34 and the stopping step 5 are detachably connected to each other by slightly rotating the third receptacle 30 along the center axis C1 when the third receptacle 30 is pushed and lifted upwards along the center axis C1 may be used.

The insulation unit is a unit for keeping the first receptacle 10, the second receptacle 20, and the third receptacle 30 warm.

In the current embodiment, the insulation unit consists of the round cover 1, the upper case 2, the lower case 3, and the base 4.

Hereinafter, an example of a method of using the maker 100 for drip coffee having the above-described elements is described.

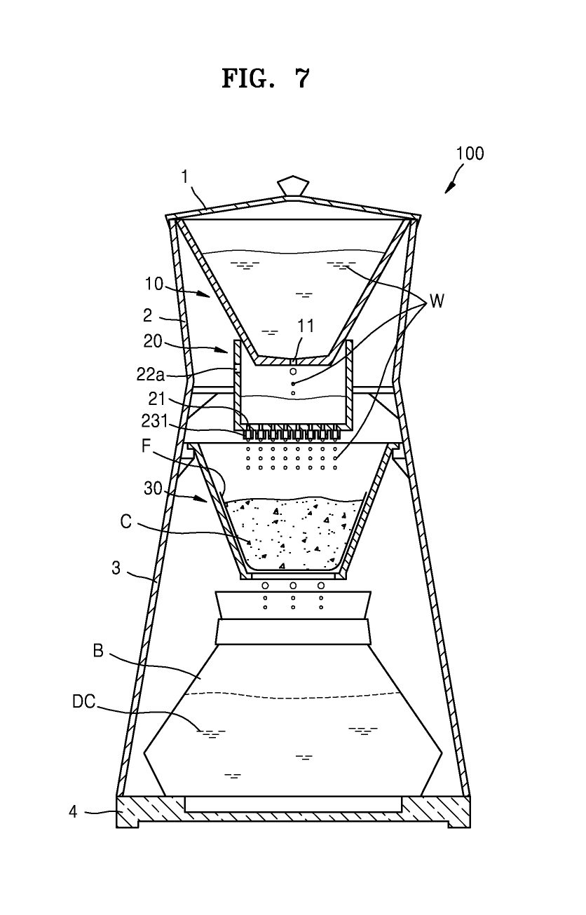

As shown in FIG. 7, a paper filter F is laid in the third receptacle 30, and 15 g of coffee powder C is put on the paper filter F. Then, the locking part 34 of the third receptacle 30 is detachably connected to the stopping step 5 on the lower case 3 via the receptacle storage hole 6.

Then, a coffee container B that is to accommodate extracted drip coffee is placed on the base 4 located below the third receptacle 30, the round cover 1 is opened, and then, 250 mL of hot water W is poured into the first receptacle 10.

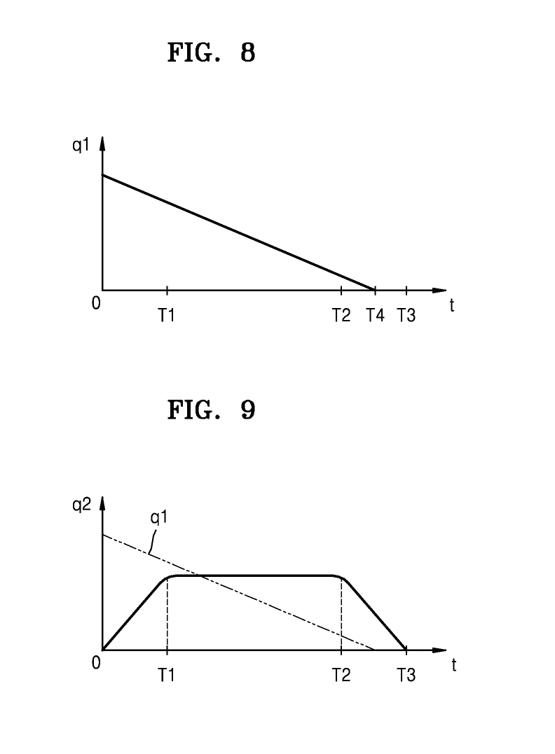

As shown in FIG. 8, in the current embodiment, whole water accommodated in the first receptacle 10 is discharged at t=T4. Here, a value of T4 is 140 seconds.

The water W accommodated in the first receptacle 10 freely falls downward via the first through hole 11, and is temporarily accommodated in the second receptacle 20.

As shown in FIG. 8, a flow rate q1 of water discharged from the first through hole 11 is decreased as a level of water in the first receptacle 10 is decreased with lapse of time t.

Then, the water W, temporarily accommodated in the second receptacle 20, freely falls downwards via the second through holes 21 onto the coffee powder C accommodated in the third receptacle 30.

As shown in FIG. 9, even though the flow rate q1 of water discharged from the first through hole 11 is greater than a flow rate q2 of water discharged from the second through holes 21 in an early period of discharging, the flow rate q1 of water discharged from the first through hole 11 is gradually decreased as time t elapses, and then, becomes equal to the flow rate q2 of water discharged from the second through holes 21. Then, the flow rate q1 of water discharged from the first through hole 11 becomes less than the flow rate q2 of water discharged from the second through holes 21.

Accordingly, as shown in FIG. 9, the flow rate q2 of water discharged from the second through holes 21 is gradually increased in an early period from t=0 to time t=T1, maintained constantly at a predetermined value in an intermediate period from t=T1 to t=T2, then, gradually decreased in a late period from t=T2 to t=T3 to reach “0”. In the current embodiment, a value of T3 is 160 seconds.

By using water discharged from the second through holes 21, a prewetting function is performed by softly wetting the coffee powder C accommodated in the third receptacle 30 in an early period of time (0≦t≦T1), and coffee is extracted from the pre-wetted coffee powder C in an intermediate period of time (T1≦t≦T2). Then, as a flow rate of water is decreased, extracting of the drip coffee DC of about 230 ml is finished in a late period of time (T2≦t≦T3). Thus, it takes about 3 minutes in total to extract the drip coffee DC.

If it takes more than 3 minutes to extract the drip coffee DC, components of a cell wall of the coffee powder C may melt and bad components that may cause unpleasant taste or aroma may be extracted in addition to useful component that leads to a bitter, sour, and sweet taste. Accordingly, the extracting of the drip coffee DC needs to be finished within 3 minutes.

The maker 100 for drip coffee having the above-described elements includes the first receptacle 10 as a receptacle that accommodates water and includes the first through hole 11 at a lower part of the receptacle 10 so as to discharge the water downward, and the second receptacle 20 that is disposed below the first receptacle 10 and includes the plurality of second through holes 21 below the second receptacle 20 as a receptacle that accommodates water discharged from the first through hole 11 so as to discharge the water W accommodated in the receptacle 20 onto the coffee powder C. The diameter D1 of the first through hole 11 is 1.4 mm to 1.9 mm, the diameter D2 of the second through hole 21 is 0.4 mm to 0.9 mm, and the water W accommodated in the second receptacle 20 is gradually discharged via the second through holes 21 at a predetermined flow rate q1 according to surface tension and viscosity of water. Thus, water may be gradually sprayed onto a large area of the coffee powder C at a low flow rate q2, according to surface tension and viscosity of water caused by a buffering function performed by the second receptacle 20 and the minute diameter D2 of the second through holes 21.

Additionally, since the maker 100 for drip coffee includes the third receptacle 30 that is disposed below the second receptacle 20 and includes the third through hole 31 at a lower part of the receptacle 10 as a receptacle that accommodates the coffee powder C and water discharged from the second through holes 21 so as to discharge the extracted drip water DC downward, the maker 100 for drip coffee may extract the drip coffee DC from coffee powder by accommodating water, freely falling from the second receptacle 20, directly in the third receptacle 30.

Additionally, in the maker 100 for drip coffee, since the first receptacle 10 has a funnel shape whose inner diameter R is reduced toward a lower part of the first receptacle 10 with a predetermined inclination angle α, a level of water accommodated in the first receptacle 10 may be decreased at a predetermined speed according to time t.

Additionally, in the maker 100 for drip coffee, since the inclination angle α of the first receptacle 10 ranges from 60 to 70 degrees, the inclination angle α may be selected by taking into account a volume of water accommodated in the first receptacle 10 and a diameter of the first through hole 11. Thus, the flow rate q1 may be easily adjusted.

Additionally, in the maker 100 for drip coffee, since the first receptacle 10 has a shape of an inverted truncated cone having a predetermined inclination angle α and the first through hole 11 is disposed on a center axis C1 of the inverted truncated cone, water accommodated in the first receptacle 10 may not be drastically discharged but may be gradually discharged via the first through hole 11, and water accommodated in the first receptacle 10 may be discharged completely.

Additionally, in the maker 100 for drip coffee, since the second through holes 21 are not on the virtual vertical line C1 extending vertically and downwards from the first through hole 11, water freely falling via the first through hole 11 may not directly pass through the second through holes 21 and may stay in the second receptacle 20 for a long period of time.

Additionally, in the maker 100 for drip coffee, since the second through holes 21 are present on the plurality of concentric circles P having a center at the vertical line C1, water may be gradually sprayed onto a large area of the coffee powder C accommodated in the third receptacle 30.

Since the maker 100 for drip coffee includes the insulation unit for keeping the first receptacle 10, the second receptacle 20, and the third receptacle 30 warm, a temperature of water accommodated therein may be maintained for a long period of time.

Additionally, since the first receptacle 10, the second receptacle 20, the third receptacle 30, the upper case 2, and the lower case 3 included in the maker 100 for drip coffee contain a transparent synthetic resin material, a user may view an amount of water accommodated inside, and a design of the maker 100 for drip coffee may be excellent.

In the current embodiment, the first receptacle 10, the second receptacle 20, the third receptacle 30, the upper case 2, and the lower case 3 are formed of a transparent synthetic resin material, but may also be formed of a semi-transparent synthetic resin material.

In the current embodiment, the first receptacle 10 has a shape of an inverted truncated cone having a predetermined inclination angle α. However, the first receptacle 10 may have a shape of an inverted cone having a predetermined inclination angle α

In the current embodiment, the receptacle storage hole 6 is open. However, a door may be mounted, whose position may be moved between a position in which the receptacle storage hole 6 is opened and a position in which the receptacle storage hole 6 is closed.

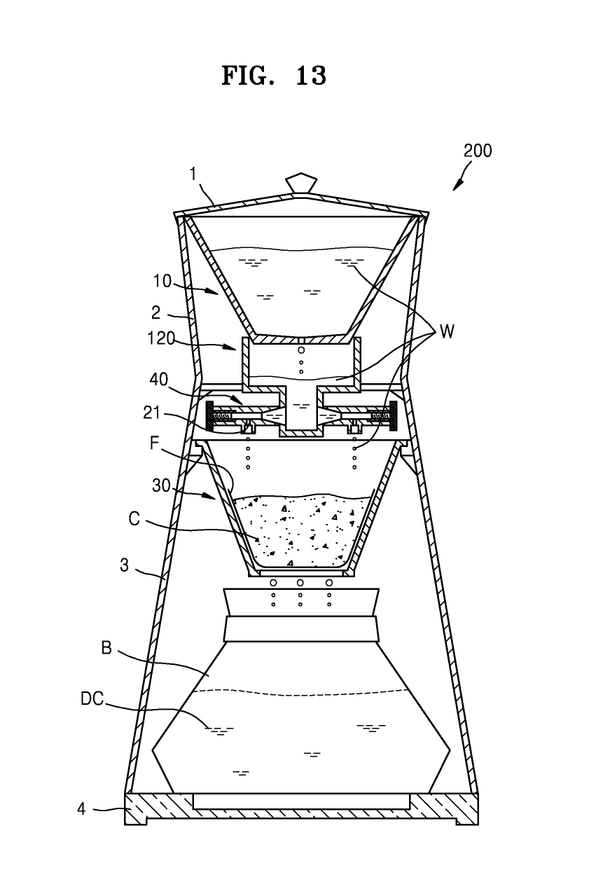

FIG. 13 is a diagram illustrating a maker 200 for drip coffee according to another exemplary embodiment of the present invention. Elements of the maker 200 for drip coffee are almost identical to those of the maker 100 for drip coffee. Thus, a description about elements that are identical between the maker 100 for drip coffee and the maker 200 for drip coffee is not provided here again, and only a description about elements of the maker 200 for drip coffee different from those of the maker 100 for drip coffee is provided here.

As shown in FIG. 11, the maker 200 for drip coffee includes a second receptacle 120. A configuration of the second receptacle 120 is almost identical to that of the second receptacle 20 included in the maker 100 for drip coffee. Thus, hereinafter, only a configuration of the second receptacle 120 different from that of the second receptacle 20 is to be described. The second receptacle 120 includes a hub 24 and branch pipes 40.

The hub 24 is a cylindrical receptacle having the center axis C1 as a center thereof. The hub 24 protrudes downwards from the bottom part 23, and is connected to the side surface part 22 and accommodates water inside the hub 24.

A plurality of branch pipes 40 are present, and are members having a shape of a circular pipe with a predetermined inner diameter D3 and extending in a predetermined length.

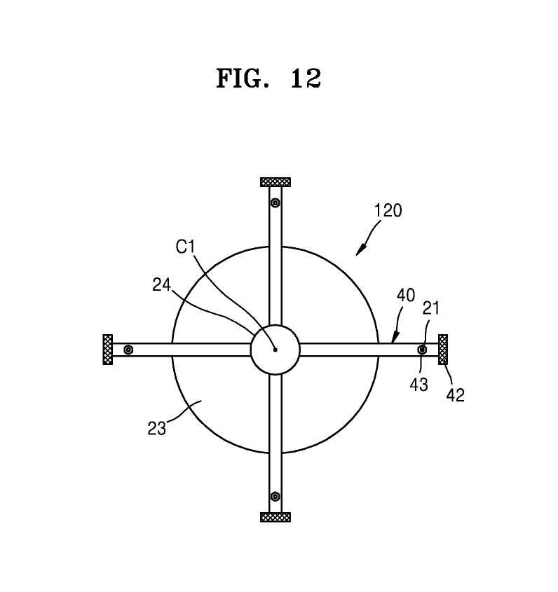

As shown in FIGS. 11 and 12, the branch pipes 40 extend horizontally and radially from the center axis C1 of the side surface part 22, and 4 branch pipes are disposed radially to have a center at the center axis C1 of the side surface unit 22.

Ends of the branch pipes 40 are connected to an outer circumferential surface of the hub 24, so that water accommodated in the hub 24 may flow into the branch pipes 40.

The second through holes 21 having a predetermined length L2 are formed on a bottom surface of the other ends of the branch pipes 40.

The second through holes 21 are formed at a position that is separate radially from the outer circumferential surface of the hub 24 in a predetermined distance L3.

An inner diameter D3 of the branch pipes 40 and the predetermined distance L3 are determined so that a flow velocity of water, flowing into the branch pipe 40, is decreased according to surface tension and viscosity. In the current embodiment, a minimum inner diameter D3 of the branch pipes 40 ranges from 1.0 to 1.5 mm, and the distance L3 is determined so that the second through holes 21 are located at an outer position than an outer circumferential surface of the side surface part 22.

The branch pipes 40 has a tapered inner structure such that the branch pipe 40 has a maximum inner diameter D4 at an end of the branch pipes 40 and, as an inner diameter is gradually decreased according to the radial distance from the center axis C1, the branch pipe 40 has the minimum inner diameter D3. In the current embodiment, the maximum inner diameter D4 ranges from 3.0 to 4.0 mm.

If a shape of the tapered inner structure of the branch pipe 40 is changed, a pressure and a flow velocity of water flowing in the branch pipe 40 are changed.

A cleaning hole 41 that is a round screw hole is formed on a side surface of the other end of the branch pipe 40. The cleaning hole 41 is connected to a hole H of the branch pipe 40.

A cover 41 having a shape of a male screw and closing the cleaning hole 41 in a watertight manner is detachably screwed to the cleaning hole 41.

An end of each of the guide members 43 that are circular pipe members is connected to a bottom surface of each of the branch pipe 40s, on which the second through hole 21 is formed, in a watertight manner.

The End of each of the guide members 43 is disposed to surround a periphery of the second through hole 21.

The other end of the guide member 43 protrudes from a bottom surface of the branch pipe 40 in a predetermined length.

In the maker 200 for drip coffee having the above-described configuration, the plurality of branch pipes 40 extending in a predetermined length and having the predetermined inner diameter D3 are connected to a lower part of the second receptacle 120, and each of the second through holes 21 is formed on an end part of each of the branch pipes 40. Thus, a flow rate q2 of water discharged via the second through holes 21 may be greatly reduced, and the flow rate q2 may be easily adjusted by adjusting the inner diameter D3 or a length of the branch pipes 40.

Additionally, in the maker 200 for drip coffee, since the branch pipe 40 extends horizontally and radially from the center axis C1 of the second receptacle 120, and a plurality of the branch pipes 40 are disposed radially from the center axis C1 of the second receptacle 120. Thus, water flowing inside the branch pipes 40 may not be accelerated due to gravity, and water may be sprayed onto a large area of the coffee powder C accommodated in the third receptacle 30.

Additionally, since the maker 200 for drip coffee includes the cleaning hole 41 formed at an end part of the branch pipes 40 and the cover 42 detachably closing the cleaning hole 41, an inside of the branch pipe 40 may be conveniently cleaned via the cleaning hole 41 after the cover 42 is separated from the branch pipes 40.

The maker 200 for drip coffee includes the guide member 43 protruding from the bottom surface of the branch pipe 40 in a predetermined length as a pipe-type member disposed to surround a periphery of the second through holes 21. Thus, the guide member 43 may prevent water, discharged from the second through holes 21, from flowing and moving along a surface of an outer circumferential surface of the branch pipes 40 and guide the water to fall downwards.

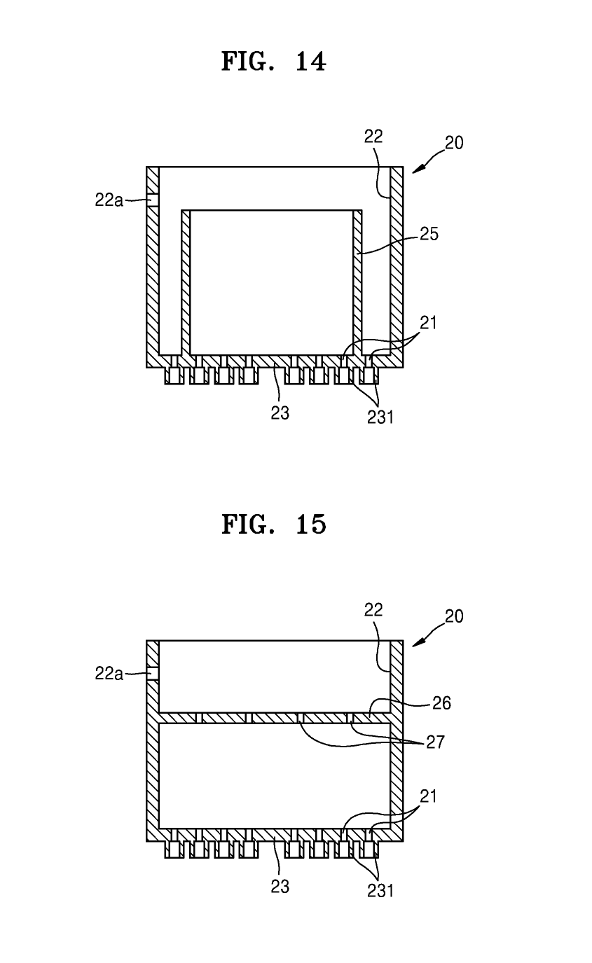

FIG. 14 is a diagram showing the second receptacle 20 included in a maker for drip coffee according to another exemplary embodiment. A configuration of the second receptacle 20 shown in FIG. 14 is almost identical to that of the second receptacle 20 included in the maker 100 for drip coffee, other than a space separation unit for separating an inner space which is included in the second receptacle 20 shown in FIG. 14. Thus, hereinafter, only a configuration of the second receptacle 20 shown in FIG. 14, which is different from that of the second receptacle 20 included in the maker 100 for drip coffee, is to be described.

The second receptacle 20 shown in FIG. 14 has a dual receptacle structure in which an inner space of the second receptacle 20 is divided into a center part and an outer part, by using a vertical barrier 25 as a space separation unit. The vertical barrier 25 is included in the second receptacle 20 and has a shape of a circular pipe, and both ends of the vertical barrier 25 are open inside the second receptacle 20.

The vertical barrier 25 is a circular pipe extending along the center axis C1 of the side surface part 22 in a predetermined length. An inner diameter of the vertical barrier 25 has a value less than that of an inner diameter of the side surface part 22, and has a shape forming a concentric circle with the side surface part 22.

Accordingly, a lower part of the vertical barrier 25 is disposed to surround second through holes 21 located in the center part, from among the second through holes 21, in a watertight manner.

The lower part of the vertical barrier 25 is connected to the bottom part 23 in a watertight manner, and the upper part of the vertical barrier 25 is open.

The upper part of the vertical barrier 25 is formed to be lower than an upper part of the side surface unit 22, so that water accommodated in the vertical barrier 25 may overflow into the side surface part 22.

Accordingly, water supplied from the first receptacle 10 is accommodated in an inner space of the vertical barrier 25 and, if a flow rate q1 of water discharged from the first through hole 11 is sufficiently high, the water may overflow into a space between the vertical barrier 25 and the side surface part 22 as time goes on.

Accordingly, if the second receptacle 20 shown in FIG. 14 is used, water is discharged from second through holes 21 located in an inner area of the vertical barrier 25, from among the second through holes 21 formed on the bottom part 23. Then, as predetermined time goes on, water is discharged from the second through holes 21 formed on the bottom part 23 in a space between the vertical barrier 25 and the side surface unit 22. Accordingly, water may be primarily supplied to a center part of the third receptacle 30, and then, supplied to an outer part of the third receptacle 30.

In other words, if the second receptacle 20 shown in FIG. 14 is used, more amount of water may be supplied to the center part of the third receptacle 30 in which the coffee powder C is accommodated in a great thickness, and less amount of water may be supplied to the outer part of the third receptacle 30 in which the coffee powder C is accommodated in a small thickness. Thus, an appropriate amount of water according to weight of the coffee powder C may be supplied to the coffee powder C accommodated in the third receptacle 30.

Additionally, when a constant amount of water is used, if the second receptacle 20 shown in FIG. 14 is used, time for which water is completely discharged through the second through holes 21 is increased compared to when the second receptacle 20 included in the maker 100 for drip coffee is used. Thus, an additional “pre-wetting effect” may be generated.

FIG. 15 is a diagram showing the second receptacle 20 included in a maker for drip coffee according to another exemplary embodiment. A configuration of the second receptacle 20 shown in FIG. 15 is almost identical to that of the second receptacle 20 included in the maker 100 for drip coffee, other than a space separation unit for separating an inner space which is included in the second receptacle 20 shown in FIG. 15. Thus, hereinafter, only a configuration of the second receptacle 20 shown in FIG. 15, which is different from that of the second receptacle 20 included in the maker 100 for drip coffee, is to be described.

The second receptacle 20 shown in FIG. 15 has a dual receptacle structure having a horizontal barrier 26 that has a shape of a circular flat plate and is horizontally disposed in the second receptacle 20 as a space separation unit.

The horizontal barrier 26 is a circular flat-plate member having the center axis C1 of the side surface part 22 as a center of a circle, and an inner diameter of the horizontal barrier 26 is identical to an inner diameter of the side surface part 22.

An outer circumferential surface of the horizontal barrier 26 is connected to an inner circumferential surface of the side surface part 22 in a watertight manner, thus dividing an inner space of the second receptacle 20 into an upper part and a lower part.

Fourth through holes 27 that are a plurality of round holes are formed on the horizontal barrier 26. Accordingly, water accommodated in the upper part of the inner space of the second receptacle 20 may flow into the lower part of the inner space of the second receptacle 20 via the fourth through holes 27.

If the second receptacle 20 shown in FIG. 15 is used, water, supplied from the first receptacle 10, is primarily accommodated in the upper part of the inner space of the second receptacle 20, which is formed by the side surface part 22 and the horizontal barrier 26. Then, as predetermined time goes on, the water secondarily flows into the lower part of the inner space of the second receptacle 20 which is formed by the side surface part 22 and the bottom part 23. Thus, when a constant amount of water is used, if the second receptacle 20 shown in FIG. 15 is used, time for which water is completely discharged through the second through holes 21 is increased compared to when the second receptacle 20 included in the maker 100 for drip coffee is used. Thus, an additional “pre-wetting effect” may be generated.

The present invention has been described more fully with reference to the accompanying drawings, in which exemplary embodiments of the inventive concept are shown. The inventive concept may, however, be embodied in many different forms and should not be construed as being limited to the embodiments set forth herein. It will be understood by those skilled in the art that various changes in form and details may be made therein without departing from the spirit and scope of the inventive concept as defined by the appended claims.

1. A maker for drip coffee configured to make drip coffee by pouring water to coffee powder obtained by finely grinding coffee beans, the maker for drip coffee comprising:
a first receptacle configured to accommodate water and comprise a first through hole at a lower part of the first receptacle so as to discharge water downwards;
a second receptacle configured to accommodate the water discharged from the first through hole, be disposed below the first receptacle, and comprise a plurality of second through holes at a lower part of the second receptacle, so as to discharge water accommodated in the second receptacle onto the coffee powder;
a third receptacle configured to accommodate the coffee powder and water discharged from the plurality of second through holes, be disposed below the second receptacle, and comprise a third through hole at a lower part of the third receptacle, so as to discharge extracted drip coffee downwards,
wherein the water accommodated in the second receptacle is gradually discharged through the plurality of second through holes at a predetermined flow rate according to surface tension and viscosity of water.

2. The maker for drip coffee of claim 1, wherein the first receptacle has a shape of an inverted funnel-type cone or an inverted funnel-type truncated cone whose inner diameter is reduced toward a lower part of the first receptacle with a predetermined inclination angle, wherein the first through hole is disposed at a center axis of the cone or the truncated cone.

3. The maker for drip coffee of claim 1, wherein the first receptacle has a size such that the first receptacle accommodates 160 to 500 mL of water, and
the second receptacle has a size such that the second receptacle accommodates 20 to 60 mL of water.

4. The maker for drip coffee of claim 2, wherein the inclination angle of the first receptacle is 60 to 70 degrees.

5. The maker for drip coffee of claim 1, wherein, in the second receptacle, the plurality of through holes are not present on a virtual vertical line extending vertically in a downward direction from the first through hole.

6. The maker for drip coffee of claim 2, wherein, in the second receptacle, the plurality of second through holes are disposed on a plurality of concentric circles having a center at a center axis of the inverted cone or inverted truncated cone.

7. The maker for drip coffee of claim 1, further comprising an insulation unit for keeping warm at least one selected from the group consisting of the first receptacle and the second receptacle.

8. The maker for drip coffee of claim 1, wherein at least one selected from the group consisting of the first receptacle and the second receptacle comprises a transparent or semi-transparent synthetic resin material.

9. The maker for drip coffee of claim 1, wherein a length of the plurality of second through holes is 1 to 2 mm.

10. The maker for drip coffee of claim 1, wherein a lower part of the second receptacle is connected to a plurality of branch pipes having a predetermined length and a predetermined inner diameter,
the plurality of second through holes are formed at ends of the plurality of branch pipes.

11. The maker for drip coffee of claim 10, wherein the plurality of branch pipes extend horizontally and radially from the center axis of the second receptacle, and are disposed circumferentially from the center axis of the second receptacle.

12. The maker for drip coffee of claim 10, further comprising a cleaning hole formed at ends of the plurality of branch pipes, and a cover configured to detachably close the cleaning hole.

13. The maker for drip coffee of claim 1, further comprising guide members that are pipe-type members disposed to surround peripheries of the second through holes, and protrude from the plurality of second through holes in a predetermined length.

14. The maker for drip coffee of claim 1, wherein the second receptacle has a dual receptacle structure in which an inner space is separated by a space separation unit so that time for which water accommodated in the second receptacle is discharged through the plurality of second through holes is increased.

15. The maker for drip coffee of claim 14, wherein the space separation unit comprises a vertical barrier which is a pipe-type member which extends in a predetermined length and whose both ends are open and is disposed inside the second receptacle in a longitudinal direction, and whose lower part is disposed to surround one or more of the plurality of second through holes in a watertight manner so as to separate an inner space of the second receptacle into a center part and an outer part.

16. The maker for drip coffee of claim 14, wherein the space separation unit comprises a horizontal barrier which is a member disposed in a horizontal direction so as to divide an inner space of the second receptacle into an upper part and a lower part, and comprises a fourth through hole formed to discharge water accommodated in the upper part of the inner space into the lower part of the inner space.

17. The maker for drip coffee of claim 1, wherein the third receptacle comprises a side surface part that has a shape of a circular pipe and is disposed below the second receptacle, and a bottom part that has a shape of a circular strip and is formed to close an edge of the lower part of the side surface part in a predetermined width, and
the third through hole is formed by an inner circumferential surface of the bottom part.
